(19) United States
(12) Patent Application Publication
(10) Pub. No.: US 2015/0295330 A1
(43) Pub. Date: Oct. 15, 2015

(54) Terminal for an Antenna Connector

(71) Applicant: Advanced-Connectek Inc., New Taipei City (TW)

(72) Inventors: Ching-Tien Chen, New Taipei City (TW); Shu-Lin Duan, New Taipei City (TW); Wei Wan, New Taipei City (TW); Xiao-Juan Qi, New Taipei City (TW)

(21) Appl. No.: 14/677,067

(22) Filed: Apr. 2, 2015

(30) Foreign Application Priority Data
Apr. 9, 2014 (CN) 201410139798.8

(51) Int. Cl. H01R 4/48

(52) U.S. Cl. CPC H01R 4/4818

(57) ABSTRACT

A terminal for an antenna connector has a soldering base, two wings, a resilient electric contacting arm, and two pre-pressing elements. The wings are formed on the soldering base and each wing has an opening. The resilient electric contacting arm is formed on and protrudes from a rear end of the soldering base and has an extension section, a resilient section, and an electronic contacting section. The pre-pressing elements are located respectively in the openings of the wings, pre-press the resilient section of the resilient electric contacting arm toward the soldering base, and limit the resilient section to sway in an extent from an inner upper edge of each opening to the soldering base. The terminal with the pre-pressing elements performs excellent electrical contacting effect to improve signal transmission of the antenna connector and a corresponding antenna module.

### BACKGROUND OF THE INVENTION

1. Field of the Invention

The present invention relates to a terminal, and more particularly to a terminal for an antenna connector that is mounted in a portable electronic device and is able to be engaged with a corresponding connector of an antenna module. Furthermore, the terminal has a pre-pressing structure to improve electronical contact and conducting functions, avoid poor contacting problems, and provide stable signal transmission.

2. Description of Related Art

Portable electronic devices such as cell phones and tablets have 3^{rd}-generation (3G) or Wireless Fidelity (Wi-Fi) wireless signal transmission modules. A conventional wireless transmission module has an antenna module mounted therein so that the portable electronic device is able to implement wireless signal transmission through the antenna modules. The portable electronic device also has an antenna connector mounted securely therein to be engaged with a corresponding connector mounted securely in the antennal module.

A conventional antenna connector of a portable electronic device has a printed circuit board (PCB) and multiple terminals mounted securely on the PCB by surface mount technology (SMT). Each terminal has a soldering section and a resilient electric contacting arm. When the antenna module is installed in the portable electronic device and engaged with the antenna connector, the resilient electric contacting arms of the terminals respectively and tightly contact pad contacts on the antenna module.

However, the aforementioned terminal has no pre-pressing structure to force and tension the resilient electric contacting arm in a tensional configuration. Therefore, the resilient electric contacting arm has a metal fatigue problem after repeated engagements and disengagements between the antenna connector and the antenna module. The fatigued resilient electric contacting arm contacting the pad contact loosely and has less contacting area with the pad contact, which makes signal transmission between the antenna module and the PCB of the electric device unstable or failed.

To overcome the shortcomings, the present invention provides a terminal for an antenna connector to mitigate or obviate the aforementioned problems.

### SUMMARY OF THE INVENTION

The main objective of the invention is to provide a terminal for an antenna connector that is mounted in a portable electronic device and is able to be engaged with a corresponding connector of an antenna module. Furthermore, the terminal has a pre-pressing structure to improve electronical contact and conducting functions, avoid poor contacting problems, and provide stable signal transmission.

A terminal for an antenna connector in accordance with the present invention has a soldering base, two wings, a resilient electric contacting arm, and two pre-pressing elements. The wings are formed on the soldering base and each wing has an opening. The resilient electric contacting arm is formed on and protrudes from a rear end of the soldering base and has an extension section, a resilient section, and an electronic contacting section. The pre-pressing elements are located respectively in the openings of the wings, pre-press the resilient section of the resilient electric contacting arm toward the soldering base, and limit the resilient section to sway in an extent from an inner upper edge of each opening to the soldering base. The terminal with the pre-pressing elements performs excellent electrical contacting effect to improve signal transmission of the antenna connector and a corresponding antenna module.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a terminal for an antenna connector in accordance with the present invention;

FIG. 2 is another perspective view of the terminal in FIG. 1;

FIG. 3 is a front view of the terminal in FIG. 1;

FIG. 4 is a top view of the terminal in FIG. 1;

FIG. 5 is a cross sectional side view of the terminal in FIG. 1;

FIG. 6 is a cross sectional front view of the terminal in FIG. 1;

FIG. 7 is a perspective view of a second embodiment of a terminal for an antenna connector in accordance with the present invention;

FIG. 8 is another perspective view of the terminal in FIG. 7;

FIG. 9 is a front view of the terminal in FIG. 7;

FIG. 10 is a top view of the terminal in FIG. 7;

FIG. 11 is a cross sectional side view of the terminal in FIG. 7; and

FIG. 12 is a cross sectional front view of the terminal in FIG. 7.

### DETAILED DESCRIPTION OF THE PREFERRED EMBODIMENT

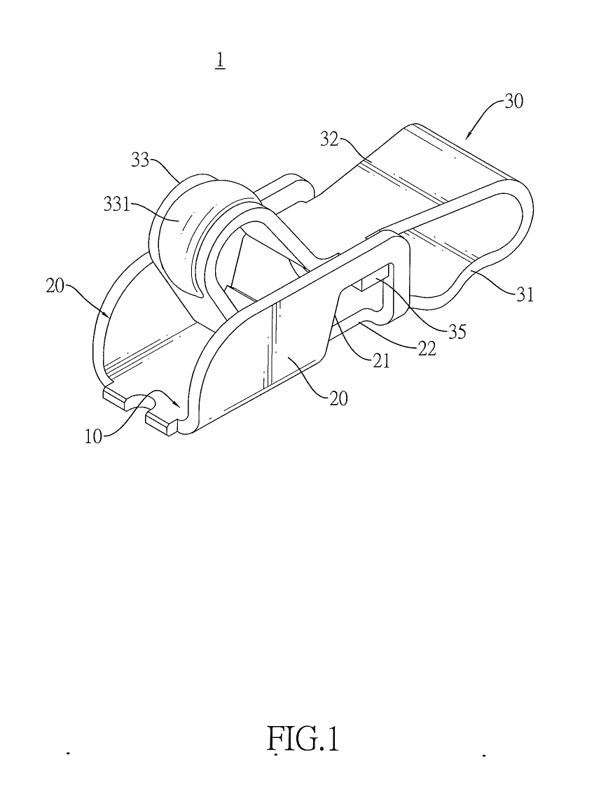

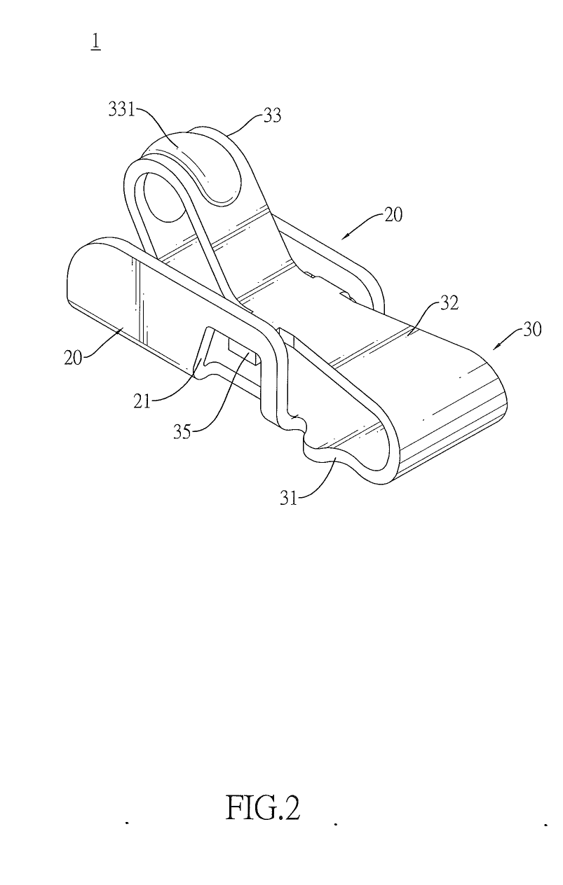

With reference to FIGS. 1 and 2, a first embodiment of a terminal 1 for an antenna connector in accordance with the present invention may be mounted in a portable electronic device and comprises a soldering base 10, two wings 20, a resilient electric contacting arm 30, and two pre-pressing elements 35.

The soldering base 10 is elongated.

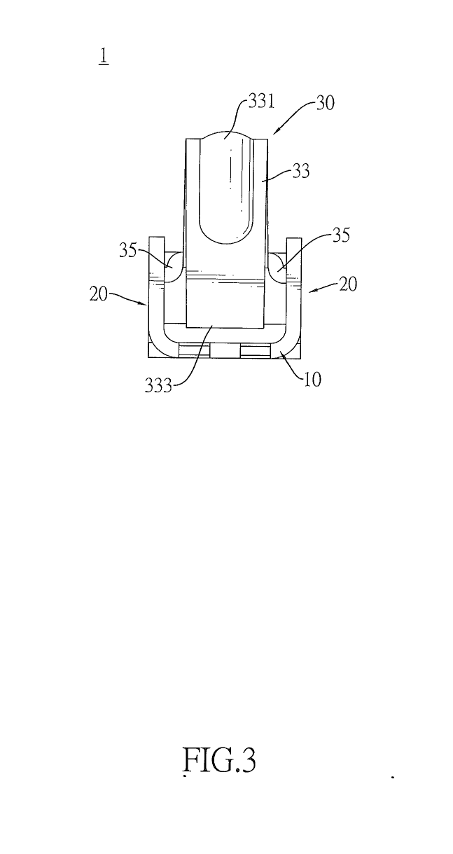

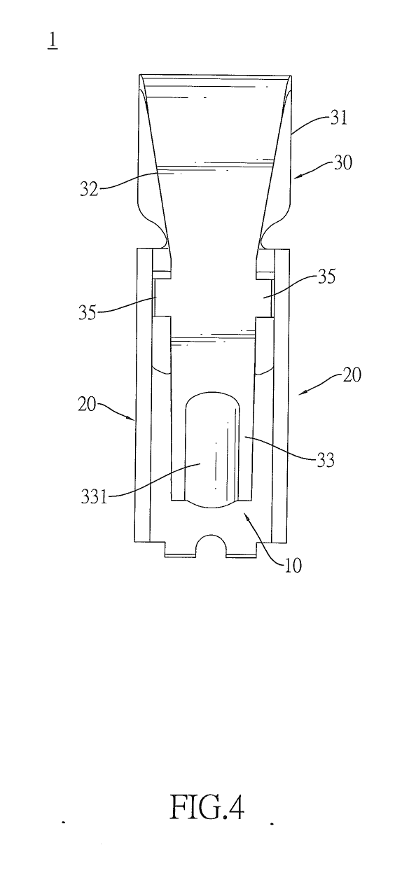

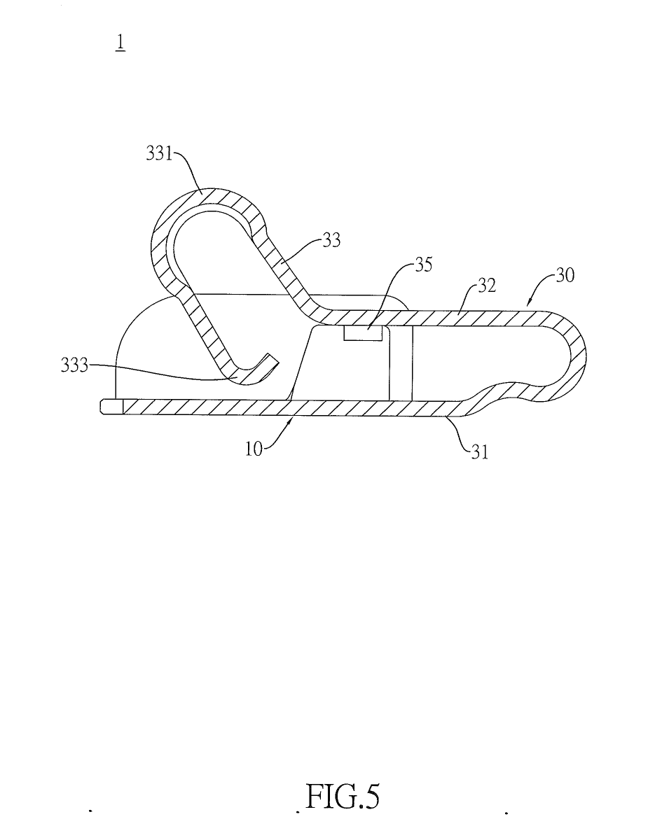

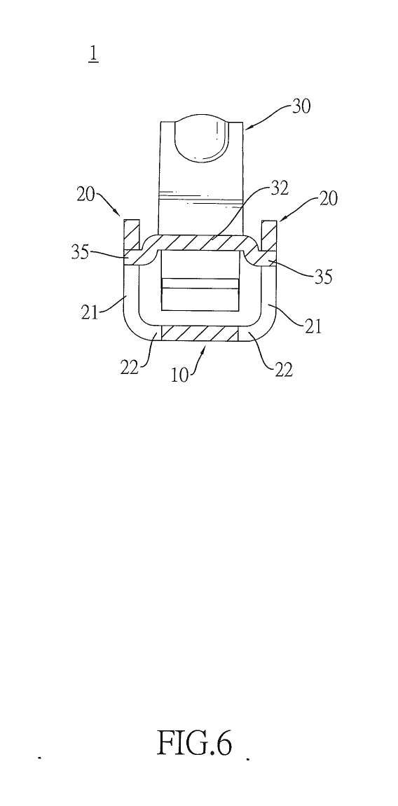

With further reference to FIGS. 3 to 6, the wings 20 are formed on and protrude upward respectively from two opposite sides of the soldering base 10. Each wing 20 has an opening 21 and may further have a solder-receiving slot 22. The opening 21 is defined transversely through the wing 20. The solder-receiving slot 22 is defined through one of the opposite sides of the base 10 and communicates with the opening 21 of the wing 20. The solder-receiving slot 22 may receive sufficient solder and increase soldering ability of the terminal 1 to a PCB during a soldering process.

The resilient electric contacting arm 30 is formed on and protrudes from a rear end of the soldering base 10 and has an extension section 31, a resilient section 32, and an electronic contacting section 33.

The extension section 31 is formed on and protrudes backward from the rear end of the soldering base 10

The resilient section 32 is formed on and protrudes forward from a rear end of the extension section 32 and is capable of resiliently swaying relative to the soldering base 10.

The electronic contacting section 33 is reverse U-shaped, is formed on and protrudes from a front end of the resilient section 32, and has a hook-like pressing portion 333. The hook-like pressing portion 333 is V-shaped, is formed on a distal end of the electronic contacting section 33, and abuts the soldering base 10 so that the soldering base 10 applies a normal force to the hook-like pressing portion 333 and the resilient electric contacting aim 30. Therefore the resilient electric contacting arm 30 is pre-pressed against and tensioned by the soldering base 10 and is able to firmly contact a corresponding pad contact or terminal of an external connector. Furthermore, the electronic contacting section 33 may have a convex portion 331 formed thereon and serving as a contacting element to improve the contacting function.

The pre-pressing elements 35 are located respectively in the openings 21 of the wings 20, pre-press the resilient section 32 of the resilient electric contacting arm 30 toward the soldering base 10, and limit the resilient section 32 to sway in an extent from an inner upper edge of each opening 21 to the soldering base 10. In the first embodiment, the pre-pressing elements 35 are formed on and protrude outward respectively from two opposite sides of the resilient section 32, extend respectively in the openings 21, and press respectively against the inner upper edges of the openings 21.

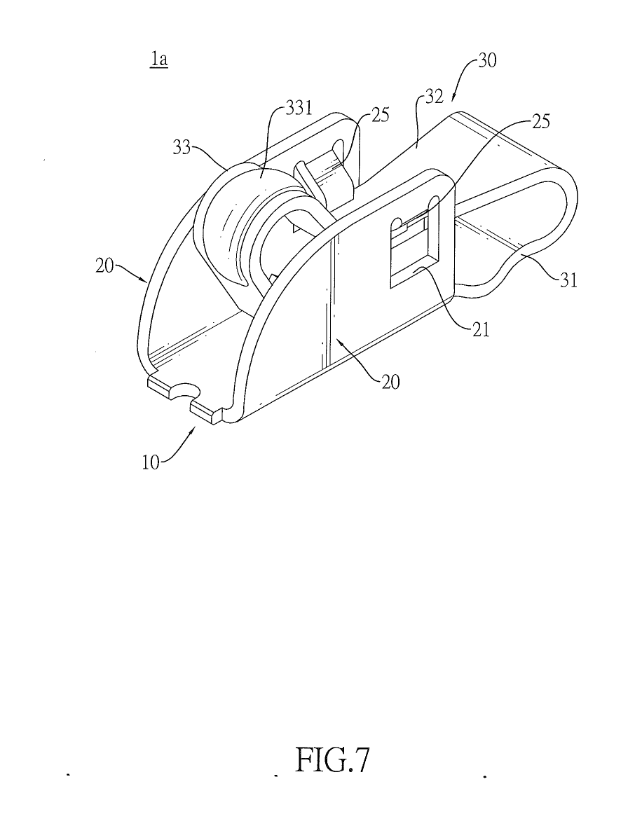

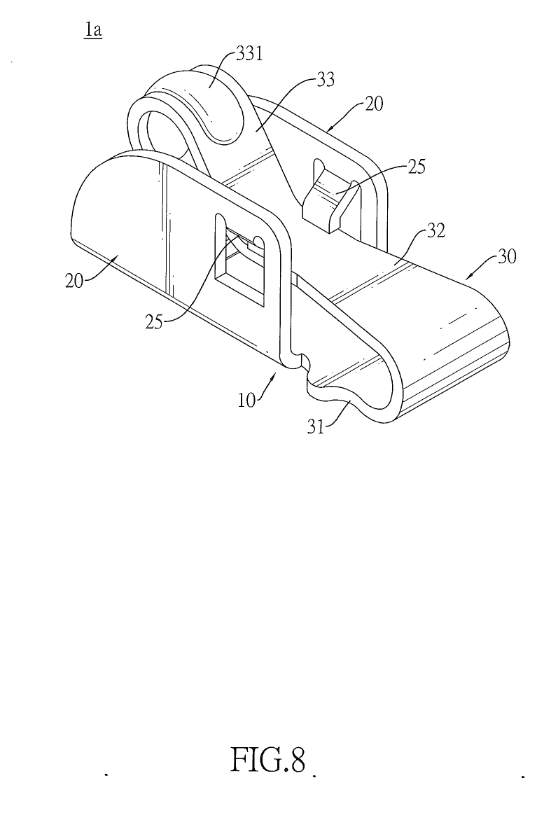

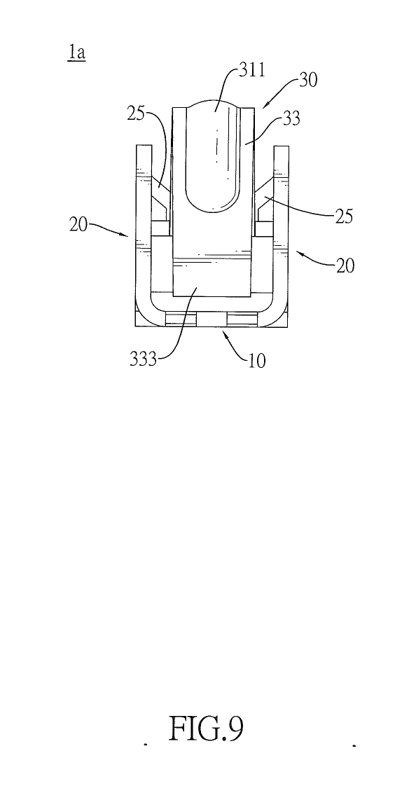

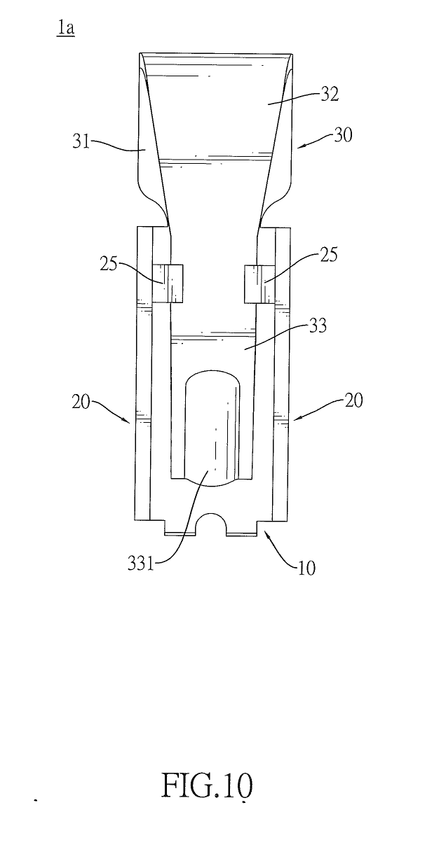

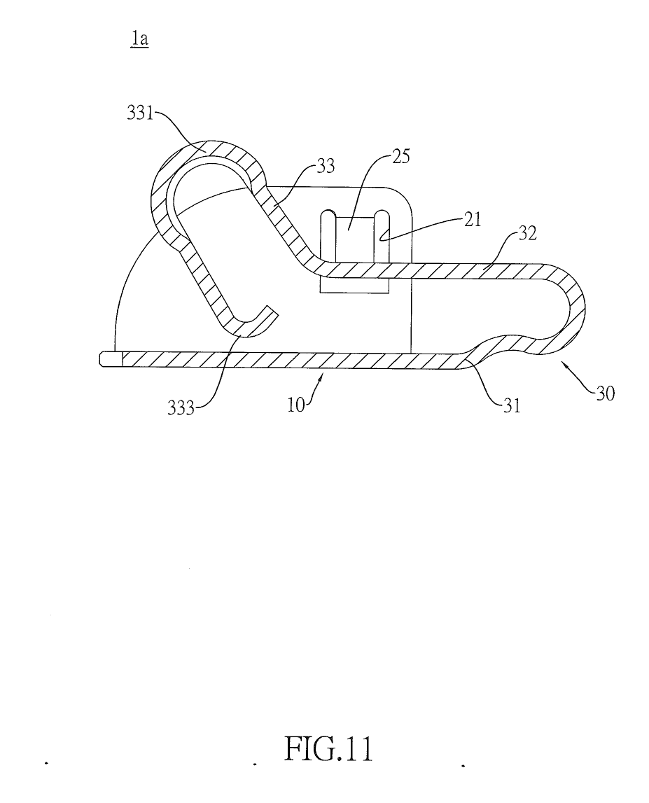

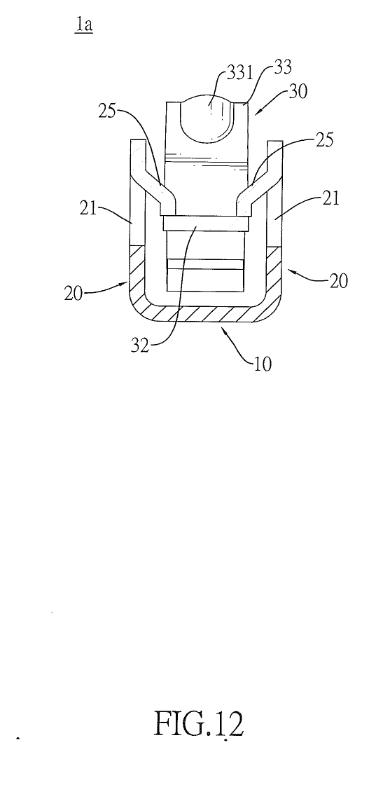

With reference to FIGS. 7 to 12, a second embodiment of the terminal 1a for an antenna connector in accordance with the present invention has a soldering base 10, two wings 20, a resilient electric contacting arm 30, and two pre-pressing elements 25. However, the pre-pressing elements 25 of the second embodiment are formed on and protrude respectively inward from the inner upper edges of the openings 21 and press against a top surface of the resilient section 32.

The terminal 1, 1a of the present invention has the following advantages.

1. The pre-pressing elements 35, 25 pre-press the resilient electric contacting arm 30 so that the resilient section 32 is resiliently deformed in a predetermined configuration and stores a sufficient resilient force. When a pad contact or a terminal on an antenna module is engaged with the terminal 1, 1a of the present invention, the resilient electric contacting arm 30 tightly contacts the pad contact or the terminal on the antenna connector with sufficient and stable resilient force. The contacting area between the terminals or the terminal 1, 1a and the pad contact is increased and impedance therebetween is reduced. Therefore, signal transmission between the portable electronic device and the antenna module is stably and efficiently implemented.

2. The V-shaped hook-like pressing portion 333 presses against the soldering base 10 so that the normal force from the soldering base 10 is applied to the resilient electric contacting arm 30 to increase the contacting strength between the resilient electric contacting arm 30 and the antenna module.

3. The convex portion 331 of the electronic contacting section 33 serves as a contacting element to improve contacting effect.

4. The solder-receiving slots 22 may receive sufficient solder and increase soldering ability of the terminal 1 to a PCB during a soldering process.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A terminal for an antenna connector comprising:
a soldering base;
two wings formed on and protruding upward respectively from two opposite sides of the soldering base, and each wing having an opening defined transversely through the wing;
a resilient electric contacting arm formed on and protruding from a rear end of the soldering base and having
an extension section formed on and protruding backward from the rear end of the soldering base;
a resilient section formed on and protruding forward from a rear end of the extension section and being capable of resiliently swaying relative to the soldering base; and
an electronic contacting section being reverse U-shaped and formed on and protruding from a front end of the resilient section; and
two pre-pressing elements located respectively in the openings of the wings, pre-pressing the resilient section of the resilient electric contacting arm toward the soldering base, and limiting the resilient section to sway in an extent from an inner upper edge of each opening to the soldering base.

2. The terminal for an antenna connector as claimed in claim 1, wherein the pre-pressing elements are formed on and protrude outward respectively from two opposite sides of the resilient section, extend respectively in the openings, and press respectively against the inner upper edges of the openings.

3. The terminal for an antenna connector as claimed in claim 1, wherein the pre-pressing elements are formed on and protrude respectively inward from the inner upper edges of the openings and press against a top surface of the resilient section.

4. The terminal for an antenna connector as claimed in claim 2, wherein the electronic contacting section has a hook-like pressing portion being V-shaped, formed on a distal end of the electronic contacting section, and abutting the soldering base.

5. The terminal for an antenna connector as claimed in claim 3, wherein the electronic contacting section has a hook-like pressing portion being V-shaped, formed on a distal end of the electronic contacting section, and abutting the soldering base.

6. The terminal for an antenna connector as claimed in claim 2, wherein the electronic contacting section has a convex portion formed thereon.

7. The terminal for an antenna connector as claimed in claim 3, wherein the electronic contacting section has a convex portion formed thereon

8. The terminal for an antenna connector as claimed in claim 2, wherein each wing has a solder-receiving slot defined through one of the sides of the base and communicating with the opening of the wing.

9. The terminal for an antenna connector as claimed in claim 3, wherein each wing has a solder-receiving slot defined through one of the sides of the base and communicating with the opening of the wing.
